(19) United States
(12) Patent Application Publication
(10) Pub. No.: US 2003/0079025 A1
(43) Pub. Date: Apr. 24, 2003

(54) Method for transmitting a data packet from a first network unit to a second network unit in a data network

(76) Inventors: Jochen Grimminger, Munich (DE); Hans-Peter Huth, Munich (DE)

Correspondence Address: MORRISON & FOERSTER LLP, 1650 TYSONS BOULEVARD, SUITE 300, MCLEAN, VA, 22102, US

(21) Appl. No.: 10/239,294

(22) PCT Filed: Mar. 14, 2001
(86) PCT No.: PCT/DE01/00966

(30) Foreign Application Priority Data
Mar. 21, 2000 (EP) 100 13 809.8

(51) Int. Cl. G06F 15/16

(52) U.S. Cl. 709/227

(57) ABSTRACT

The invention relates to a method and an arrangement for transmitting a data packet from a first network unit to a second network unit in a data network. A first connection information unit is transmitted to the first network unit. A connection is established between the first network unit and the second network unit by means of said first connection information unit. The first network unit assigns a second connection information unit to the data packet. The data packet is subsequently transmitted to the second network unit by means of the first network unit using the second connection information unit.

The invention relates to the transmission of a data packet in a data network.

Such transmission of a data packet in a data network is known from [1].

Generally an information unit, which is made available in the data network by an information supplier, is transmitted in a data network to a user by the information supplier.

In a packet-based data network, for example an IP data network, the information unit is transmitted in the form of a data packet. In graphic terms, the information unit is “packaged” in the form of a packet, in this case a data packet, and transmitted with the data packet.

Generally such a data packet is provided with what is known as a label or header, comparable to an address, which specifies as a minimum a destination address for transmission of the data packet.

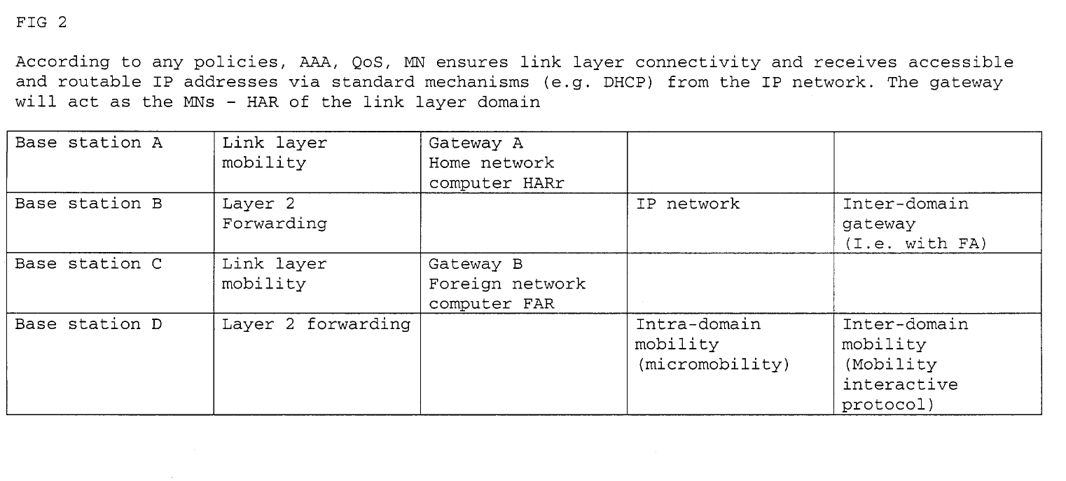

FIG. 2 shows such an IP data network 200 and transmission of a data packet 210 in diagrammatic form.

The organization of such an IP data network 200 is also known from [1] or [3].

A data packet 210 is also described in [1] or [3].

In order to ensure that a data packet is also transmitted to the user in the data network, for whom it is intended, the user must use a network service, which is supplied by a network unit, known as a gateway or router.

Such a router 220 and 221 is also shown in FIG. 2 and known from [2].

A network service generally routes a data packet in the data network and thereby ensures that the data packet is also transmitted to the user requesting it.

A user can use network services from different network units in a data network.

All data packets to be transmitted to the user are transmitted to a network unit, which then transmits these on to the user.

If a user, for example a mobile telephone 230 (see FIG. 2) is not yet in the data network, in this case a mobile communication network 200 to which said user requires access, the user must first establish a connection with a network unit, the router 221 and 220, in the data network.

The mobile telephone 230 does this by dialing in or logging on to the mobile communication network 200 and being connected as a result to a network unit 221, in the range of influence of which the mobile telephone 230 is currently located (home access router 221).

The network unit, to which the mobile telephone originally dials in or logs on, is referred to as the home access router 221.

This dialing in or logging on process is, for example, carried out in accordance with a point to point protocol or a dynamic host configuration protocol, as described in [4] or [5].

When a mobile telephone dials in or logs on to a mobile communication network, what are known as connection parameters, for example, transmission quality or a security mechanism, are agreed or defined between the mobile telephone and the competent network unit.

Such connection parameters are described in [4] or [5].

Also during the log-on process, the mobile telephone is assigned a fixed address, known as an IP address.

This address is valid, as long as the mobile telephone 230 is logged on to the competent network unit, the home access router 221.

If a mobile telephone wishes to or has to change network unit, for example because the mobile telephone changes its geographical position and as a result moves from the range of influence of an original first network unit (home access router 221) into the range of influence of a new second network unit (foreign access router 220), the connection set up between the mobile telephone and the original first network unit 221 must be terminated and a new connection must be set up with the new second network unit 220.

When the new connection is set up, the mobile telephone logs on again to the new network unit. The connection parameters and the IP address must be newly defined or agreed. Only than is the correct transmission of a data packet to the mobile telephone ensured.

All the connection parameters defined during the original connection are lost.

The invention has to resolve the problem of specifying a method and arrangement which improve the transmission of a data packet in a data network to a user changing from a first network unit to a second network unit in the data network.

The problem is resolved by means of the method and arrangement according to the respective independent Claim.

In the case of a method for transmitting a data packet from a first network unit to a second network unit in a data network, transmission takes place to the first network unit. A connection is established between the first network unit and the second network unit using the first connection information unit. A second connection information unit is assigned to the data packet from the first network unit. The data packet is then transmitted from the first network unit to the second network unit using the second connection information unit.

An arrangement for transmitting a data packet in a data network has a first network unit, a second network unit and a connection between the first network unit and the second network unit, which connection can be established using a first connection information unit, which first connection information unit was transmitted to the first network unit. The first connection unit is established in such a way that a second connection information unit can be assigned to the data packet. Also the first network unit and the second network unit are established in such a way that the data packet can be transmitted from the first network unit to the second network unit in the data network using the second connection information unit.

The arrangement is particularly appropriate for implementation of the method according to the invention or a development described after this.

The particular advantage of the invention is that certain existing connection parameters can be retained. Certain connections in the data network can therefore be maintained even when the network unit changes.

It should be pointed out that a connection can refer to both a physical and a virtual connection.

Preferred developments of the invention result from the dependent Claims.

The developments described below relate both to the method and to the arrangement.

The invention and the developments described below can be implemented by means of both software and hardware, for example using a special electrical circuit.

Also the invention or a development described below can be implemented using a computer-readable storage medium, on which a computer program is stored, which executes the invention or development.

Also the invention and/or any development described below can be implemented by means of a computer program product, which has a storage medium, on which a computer program is stored, which executes the invention and/or development.

The connection between the first and second network units can be established if the first connection information unit contains at least one of the following information units:

a data network management information unit,

a security information unit,

a quality information unit,

a cost information unit,

a user information unit,

a destination information unit.

It should however be pointed out that the above list of information units should not be seen as exhaustive but that the first connection information unit may contain further information units.

For secure transmission of the data packet to a destination unit, for example a communication terminal, the second connection information unit is preferably an address.

Such an address may be a Multi-Protocol-Label-Switching address (MPLS label).

For a more precise definition of a transmission characteristic in the data network, the address can preferably be linked with at least one of the following information units:

a data network management information unit,

a security information unit,

a quality information unit,

a cost information unit,

a user identification information unit,

a destination information unit

a tunnel information unit

a data transmission information unit.

It should however be pointed out that the above list of information units is not exhaustive but that the address may be linked with other information units.

The information units may also be coded and contained in the address in code form or stored in a list.

The second connection information unit may be assigned only temporarily to the data packet. It is therefore expedient to assign the second connection information unit to the data packet in the first network unit (labeling). The second connection information unit is separated from the data packet again in the second network unit (delabeling).

Establishment of the connection can be understood to mean that the connection is newly established using the first connection information unit or that an already established connection is newly configured using the first connection information unit.

In one embodiment the connection comprises a plurality of sub-connections. In this case, the connection runs from the first network unit to the second network unit via intermediate network units. It is also conceivable that these sub-connections might connect the first and second network units in parallel. A combination of the two options, parallel or in series, is also conceivable.

The first and second network units and also the intermediate network units may be what are known as routers, switches or gateways.

In a development, the connection and/or the sub-connection is a tunnel. Such a tunnel may specifically be a Multi-Protocol-Label-Switching L abel-Switched-Path tunnel (MPLS LSP tunnel).

In one embodiment the data network is an IP communication network.

In an IP communication network, the data packet is generally transmitted from a data source via one or more network units, which route the packet further on, to a communication terminal, for example a mobile telephone. In the process, the communication terminal is logged on to a network unit assigned to the communication terminal, known as a home access router. Generally the communication terminal is also connected to this home access router.

If however the communication terminal is connected to a “foreign” network unit, known as a foreign access router, to which the communication terminal has not logged on, and the communication terminal does not log on again to this foreign access router, the data packet can generally not be transmitted securely from the data source to the communication terminal.

In such a case, it is useful to deploy a development of the invention for transmission of the data packet, as this increases the level of security during transmission.

This makes it possible for the first connection information unit to be transmitted to the first network unit from the second network unit or the communication terminal or a third unit in the data network.

With this development, the data packet is transmitted from the data source to the first network unit, on via the connection to the second network unit and then to the communication terminal.

The transmission route may also be reversed.

An embodiment of the invention is shown in the Figures and is described in more detail below.

The figures show:

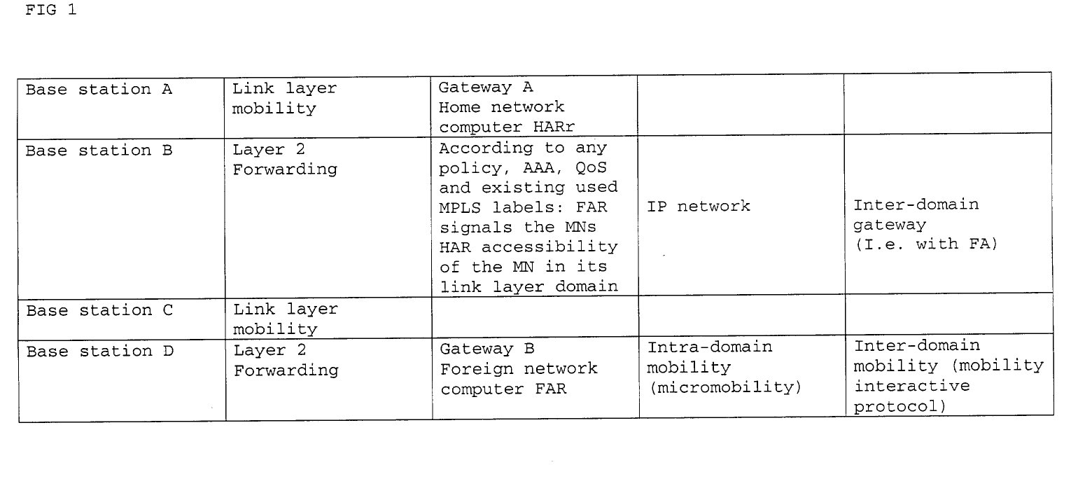

FIG. 1 a sketch of an IP data network according to an embodiment;

FIG. 2 a sketch of an IP data network;

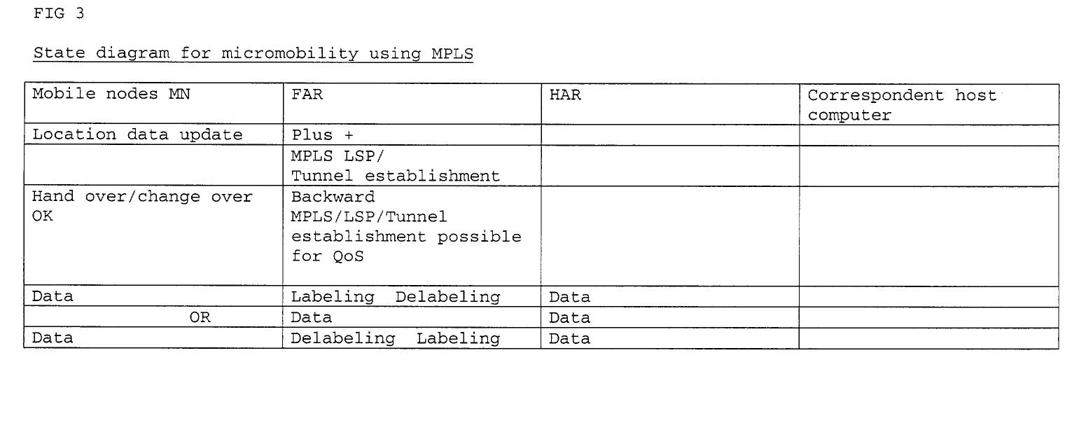

FIG. 3 a sketch showing a method flow for the transmission of a data packet in an IP data network according to an embodiment;

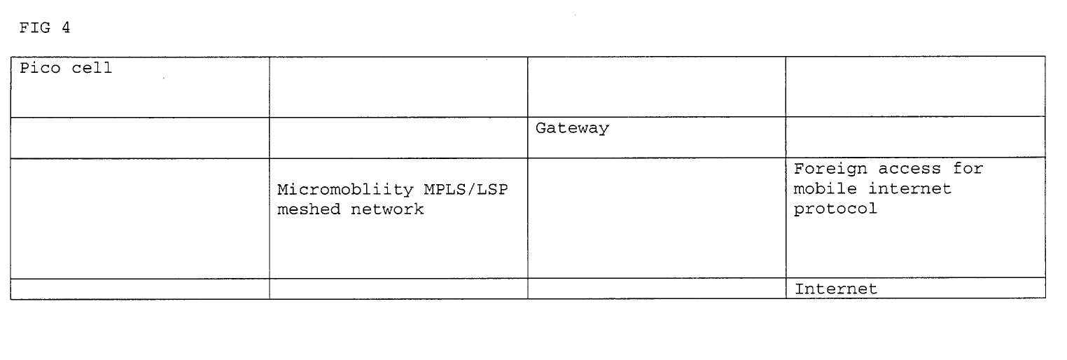

FIG. 4 a sketch of an IP data network, in. which the mobility of a mobile unit is illustrated between a number of network units.

### EMBODIMENT: DATA TRANSMISSION IN AN IP DATA NETWORK

FIG. 1 shows the structure of an IP data network 100 with associated components for transmitting a data packet 101 in the IP data network 100.

The structure according to FIG. 1 does not show a minimal configuration of the IP data network 100. Various components are solely intended to enhance user-friendliness. They are however not necessary for the operation of the IP data network 100.

This IP data network 100 is organized and structured according to a layer model, which is described in [6].

The components of the IP data network 100 according to FIG. 1 described below are for the most part standard components of an IP data network, which are generally known to the person skilled in the art.

FIG. 1 shows the IP data network 100, which contains a data source 110, for example a database, a first 130 and a second 131 router, a gateway A 130 and a gateway B 131.

The routers 130, 131 are each connected to the data source 110 by means of data lines 140, 141, via which the data packet 101 can be transmitted in the IP data network 100.

FIG. 1 shows a mobile communication terminal 150, a mobile telephone 150.

The mobile telephone 150 is logged on to the first router 130. The first access router 130 is in this case described as what is known as a home access router 130.

When the mobile telephone 150 logs on to the home access router 130, the home access router 130 assigns what is known as an IP number to the mobile telephone 150.

The IP numbers assigned for this purpose are uniquely “routable” in the IP data network 100 [2].

This IP number is used to make the mobile telephone accessible for the IP data network 100 on layer 3.

FIG. 1 also shows that the mobile telephone 150 has left the range of influence of the home access router 130 and is now in the range of influence of the second access router 131, known as a foreign access router 131.

Data packets are transmitted between the mobile telephone 150 and the foreign access router 131 according to the layer model, which is described in [6].

FIG. 1 also shows what is known as a Multi-Protocol-Label-Switching L abel-Switched-Path tunnel (MPLS LSP tunnel) 160, which connects the home access router 130 to the foreign access router 131.

Basic features of an MPLS LSP tunnel are known from [7].

To set up this MPLS LSP tunnel 160 between the foreign access router 131 and the home access router 130, connection information units are transmitted from the foreign access router 131 to the home access router.

The connection information units are used to define the configuration of the MPLS LSP tunnel 160 to be established.

The following is defined:

the transmission route a data packet 101 has to take between the home access router 130 and the foreign access router 131,

the security standards to be complied with for a transmission between the home access router 130 and the foreign access router 131 in the MPLS LSP tunnel 160,

the quality standards to be complied with for a transmission between the home access router 130 and the foreign access router 131 in the MPLS LSP tunnel 160 (quality of service),

the label to be used to mark a data packet 101 transmitted between the home access router 130 and the foreign access router 131 in the MPLS LSP tunnel 160,

the speed with which a data packet 101 is to be transmitted between the home access router 130 and the foreign access router 131 in the MPLS LSP tunnel 160,

the costs to be charged for transmission of a data packet between the home access router 130 and the foreign access router 131 in the MPLS LSP tunnel 160.

Other connection information units, for example information units relating to the mobile telephone 150 and/or the data source 110, which can also be used to configure the MPLS LSP tunnel 160, can also be transmitted from the foreign access router 131 to the home access router 130.

It should be noted that these information units do not necessarily have to be transmitted from the foreign access router 131 to the home access router but can also be transmitted from a third unit, for example the mobile telephone 150.

It should also be pointed out that the connection information units described should not be seen as exhaustive.

The connection information units also indicate to the home access router 130 that the mobile telephone 150 is in the range of influence of the foreign access router 131.

This means that data packets, which are transmitted between the IP data network 100 and the mobile telephone 150, have to be transmitted to the foreign access router 131 and be routed on from this to the mobile telephone 150.

The MPLS LSP tunnel is established according to the defined configuration.

The transmission of a data packet 101 between the data source 110 and the mobile telephone 150 is described below.

### a) Transmission of a Data Packet 101 from the Mobile Telephone 150 to the Data Source 110

If the mobile telephone 150 requests an information unit from the data source 110, a corresponding request data packet is transmitted from the mobile telephone 150 to the data source 110.

For this, the request data packet is provided or addressed in the mobile telephone with a destination address, which defines the data source 110 as the transmission destination.

The addressed data packet is transmitted from the mobile telephone 150 to the foreign access router 131 according to the layer model. The addressed data packet is analyzed in the foreign access router 131 and routed on or transmitted further.

During the further transmission of the addressed data packet to the data source 110 the addressed data packet must be routed on by other routers as required.

FIG. 1 shows a direct connection, the data line 141, via which the addressed data packet is transmitted to the data source 110, for simplification only.

At the end of the transmission the request data packet reaches the data source 110. It is analyzed there. The request is processed.

### b) Transmission of a Data Packet 101 from the Data Source to the Mobile Telephone 150

The data source 110 compiles a response data packet, which is sent back to the mobile telephone 150.

The response data packet is provided or addressed with the IP number as the destination address, which defines the mobile telephone 150 as the transmission destination.

The addressed response data packet is transmitted from the data source 110 to the home access router 130 first.

FIG. 1 shows a direct connection, the data line 140, via which the response data packet is carried to the home access router 130, for simplification only.

Transmission via a plurality of different routers would be possible.

The home access router 130 was informed, when the MPLS LSP tunnel was set up, that the mobile telephone 150 is currently in the range of influence of the foreign access router 131.

The home access router 130 therefore “knows” that it has to route or transmit the response data packet, which is intended for the mobile telephone 150, further on to the foreign access router 131.

For the transmission of the response data packet between the home access router 130 and the foreign access router 130, the home access router 130 provides the response data packet with what is known as an MPLS LSP label.

Such an MPLS LSP label is described in [7].

In graphic terms, the response data packet is temporarily, i.e. only for transmission between the home access router 130 and the foreign access router 131, readdressed to the foreign access router 131. The original destination address, the IP number of the mobile telephone, is retained but is temporarily masked by the MPLS LSP label.

This MPLS LSP label is linked with the following information units:

a data network management information unit,

a security information unit,

a quality information unit,

a cost information unit,

a user identification information unit,

a destination information unit

a tunnel information unit

a data transmission information unit.

It should be pointed out that the information units described, which are linked with the MPLS LSP label, should not be seen as exhaustive. Other links are possible.

The information units are coded in the form of a numerical code.

The response data packet “addressed” with the numerical code or MPLS LSP label is transmitted via the MPLS LSP tunnel 160 from the home access router 130 to the foreign access router 131.

The MPLS LSP label is again separated from the response data packet in the foreign access router 131. The response data packet again has the original destination address, the IP number of the mobile telephone 150.

According to the layer model, the response data packet is transmitted from the foreign access router 131 to the mobile telephone 150.

At the end of the transmission the response data packet reaches the mobile telephone 150. It is analyzed and “unpacked” there, making user data available to the mobile telephone 150.

It should be noted that the transmissions described above are carried out on the basis of known transmission standards. Corresponding known data protocols are used.

FIG. 3 shows a flow diagram with a method flow 300, which describes diagrammatically the interaction of individual components in an IP data network during transmission of a data packet.

The IP data network contains a mobile unit 310, described in FIG. 3 as mobile node MN, a foreign access router 320, a home access router 330 and what is known as a correspondent host (data source) 340.

The mobile node 310 is logged on to the home access router 330 but is located in a range of influence of the foreign access router 320.

In this case, the mobile node 310 informs the foreign access router 320 that it is in its range of influence and must therefore use a network service of the foreign access router 320 for transmission of a data packet (location update 350).

The foreign access router 320 for its part now informs the home access router 310 that the mobile node is in its range of influence and therefore a data packet, which is intended for the mobile node 310 and has been transmitted to the home access router 330, has to be routed on to the foreign access router (location update plus +, 351).

The foreign access router 320 also sends connection information units to the home access router 330, which can be used to set up an MPLS LSP tunnel between the foreign access router 320 and the home access router 330 (location update plus +, 351).

In further stages 360 and 362 the MPLS LSP tunnel is set up according to the connection information units (MPLS LSP tunnel establishment, 360 and backward MPLS LSP tunnel establishment, 362).

The foreign access router 320 informs the mobile node 310 that a connection has been established between the mobile node 310 and the IP data network (hand over/change over OK, 361).

During transmission of a data packet from the mobile node 310 to the correspondent host 340, the data packet is transmitted in one stage 370 from the mobile node 310 to the foreign access router 320.

The data packet is routed on from the foreign access router 320 and transmitted to the correspondent host 340 (stage 373 and stage 374 or stage 371 and stage 372).

This transmission can take place via two different transmission routes:

a) The data packet receives a label from the foreign access router 320 and this label shows the home access router 330 as the destination address. The data packet is then transmitted via the MPLS LSP tunnel to the home access router 330. The label is again removed from the data packet at the home access router 330 (stage 371).

The data packet is transmitted on to the correspondent host 340 from the home access router 330 (stage 372).

b) The data packet is transmitted directly from the foreign access router 320 (without going via the home access router 330) to the correspondent host 340 (stage 373 and stage 374).

A data packet, which is transmitted back from the correspondent host 340 to the mobile node 310, is transmitted in one stage 375 from the correspondent host 340 to the home access router 330 (stage 375).

At the home access router 330 the data packet receives a label (stage 376), which shows the foreign access router 320 as the destination address.

The label contains further information units, known as connection information units, which are used for transmission via the MPLS LSP tunnel.

The “labeled” data packet is then transmitted from the home access router 330 via the MPLS LSP tunnel to the foreign access router 320 (stage 376).

The label is again separated from the data packet at the foreign access router 320 (stage 376).

In a further stage 377 the data packet is transmitted from the foreign access router 320 to the mobile node 310 (stage 377).

FIG. 4 is a diagrammatic illustration of the mobility of a mobile unit 420 between a plurality of routers 410 in an IP data network 400.

The IP data network 400 shown in FIG. 4 has the same functionality as the IP data network according to the embodiment shown in FIG. 1.

MPLPS LSP tunnels as described above can also be set up as required between the routers 410 shown in FIG. 4.

FIG. 4 shows a number of routers 410 in the IP data network 400. A mobile unit, in this case a mobile host 420, is also shown.

Arrows 430 show the mobility of the mobile host 420. The mobile host 420 changes its position according to the arrows 430 and as a result moves into the range of influence of different routers 410.

In order to ensure secure data transmission between a data source and the mobile host 420, without the host having to log on to every new access router 410, log off from the old access router 410 and each time define new connection parameters, an MPLS LSP tunnel according to the previous embodiments is established or used in each instance between the (fixed) home access router and the current foreign access router.

Data, which is exchanged between the mobile host 420 and the data source, is transmitted via these tunnels.

In graphic terms, the access routers 410 are networked by the MPSL tunnels. The mobile host 420 can be “handed over” from one router 410 to another router 410 in any changes between different routers 410.

The following publications are cited in this document:

[1] W. Richard Stevens; TCP/IP Illustrated, Volume 1, Chapter 3, pages 33-53, Edison Wesley, 1994, Reading, USA;

[2] W. Richard Stevens; TCP/IP Illustrated, Volume 1, Chapter 9, pages 111-126, Edison Wesley, 1994, Reading, USA;

[3] www.IETF.org/rfc/rfc0791.txt, Request For Comment (RFC) 791, Standard IETF, 1981, available on 21.03.2000;

[4] www.IETF.org/rfc/rfc1548.txt, (PtP), Request For Comment (RFC) 791, Standard IETF, 1981, available on 21.03.2000;

[5] www.IETF.org/rfc/rfc2131.txt, (DHCP), Request For Comment (RFC) 791, Standard IETF, 1981, available on 21.03.2000;

[6] W. Richard Stevens; TCP/IP Illustrated, Volume 1, Chapter 1, pages 1-21, Edison Wesley, 1994, Reading, USA;

[7] www.IETF.org/internet-drafts/draft-IETF-MPLSframework-05.txt, available on 21.03.2000.

1. Method for transmitting a data packet from a first network unit via a second network unit to a communication terminal in a data network,
in which the communication terminal enters the communication range of a second network unit,
in which this entry initiates transmission of a first connection information unit to the first network unit,
in which a connection is established between the first network unit and the second network unit using the first connection information unit,
in which a second connection information unit is assigned to the data packet from the first network unit,
in which the data packet is transmitted from the first network unit via the second network unit to the communication terminal using the second connection information unit.

2. Method according to claim 1, in which on entry of the communication terminal into the communication range of the second network unit, the communication terminal is logged on to the second network unit.

3. Method according to claim 1 or 2, in which the first connection information unit is transmitted from the second network unit to the first network unit.

4. Method according to claim 1 or 2, in which the first connection information unit is transmitted from the communication terminal or a third unit in the data network to the first network unit.

5. Method according to one of the preceding claims, in which the communication terminal enters the communication range of the second network unit from a communication range of the first network unit.

6. Method according to one of the preceding claims, in which the first connection information unit contains at least one of the following information units:
a data network management information unit,
a security information unit,
a quality information unit,
a cost information unit,
a user information unit,
a destination information unit.

7. Method according to one of the preceding claims, in which the second connection information unit is an address.

8. Method according to claim 7, in which the address is a Multi-Protocol-Label-Switching address (MPLS label).

9. Method according to claim 7 or 8, in which the address contains at least one of the following information units:
a data network management information unit,
a security information unit,
a quality information unit,
a cost information unit,
a user identification information unit,
a destination information unit
a tunnel information unit
a data transmission information unit.

10. Method according to one of the preceding claims, in which the connection comprises a plurality of sub-connections, each of which connects two intermediate network units.

11. Method according to one of the preceding claims, in which the connection and/or the sub-connection is a tunnel.

12. Method according to claim 11, in which the tunnel is a Multi-Protocol-Label-Switching L abel-Switched-Path tunnel (MPLS LSP tunnel).

13. Method according to one of the preceding claims, in which the data network is an IP communication network.

14. Method according to one of the preceding claims, in which the data packet is transmitted from a data source to the communication terminal, with the data packet being transmitted from the data source to the first network unit, on via the connection to the second network unit and then to the communication terminal.

15. Method according to one of the preceding claims,
in which the communication terminal enters a communication range of a third network unit in the data network from the communication range of the second network unit,
in which this entry into the communication range of the third network unit initiates transmission of a further first connection information unit from the third network unit to the first network unit,
in which a connection is established between the first network unit and the third network unit using the further first connection information unit,
in which a further second connection information unit is assigned to a further data packet from the first network unit,
in which the further data packet is transmitted from the first network unit via the third network unit to the communication terminal using the further second connection information unit.

16. Method according to one of the preceding claims, with a plurality of such entries of the communication terminal in each instance into a communication range of a further network unit from a plurality of further network units, whereby on each entry into one of the communication ranges a connection is established between the first network unit and the respective further network unit, by means of which a data packet is transmitted from the first network unit to the communication terminal.

17. Arrangement for transmitting a data packet from a first network unit via a second network unit to a communication terminal in a data network,
which is established in such a way that entry of the communication terminal into a communication range of the second network unit initiates transmission of a first connection information unit to the first network unit,
which is established in such a way that a connection is established between the first network unit and the second network unit using the first connection information unit,
in which arrangement the first network unit is established in such a way that a second connection information unit is assigned to the data packet and the data packet is transmitted from the first network unit via the second network unit to the communication terminal using the second connection information unit.
